(19) United States
(12) Patent Application Publication
(10) Pub. No.: US 2021/0181776 A1
(43) Pub. Date: Jun. 17, 2021

(54) INTERFACE ARRANGEMENT, COMPUTER SYSTEM AND METHOD

(71) Applicant: Fujitsu Client Computing Limited, Kawasaki (JP)

(72) Inventors: Waldemar Felde, München (DE); Ales Diessner, München (DE)

(21) Appl. No.: 17/120,780

(22) Filed: Dec. 14, 2020

(30) Foreign Application Priority Data
Dec. 16, 2019 (DE) 102019134551.0

(51) Int. Cl. G05F 1/625; G06F 1/26; G06F 13/42

(52) U.S. Cl. CPC G05F 1/625; G06F 2213/0042; G06F 13/4282; G06F 1/266

(57) ABSTRACT

An interface arrangement includes a first interface via which a first power supply can be provided, at least one second interface via which at least one second power supply can be provided, and a control device. The first interface is connected to the control device via a connector of a first or a second type. The control device is configured to detect whether the first interface is connected to the control device via the connector of the first type or of the second type. The control device is further configured to limit the at least one second power supply provided at the at least one second interface depending on the detected type of the con-nector.

### TECHNICAL FIELD

This disclosure relates to an interface arrangement comprising a first interface via which a first power supply can be provided, and at least one second interface via which at least one second power supply can be provided, as well as to a computer system comprising such an interface arrangement, and a method for such an interface arrangement.

### BACKGROUND

Interface arrangements with multiple interfaces, for example, in computer systems or other electronic devices via each of which a power supply for a connected device can be provided, are known. Such interfaces include, for example, USB interfaces, FireWire interfaces, Lightning interfaces and the like. As computer technology advances, the amounts of power provided via such interfaces and consumed by connected devices increase.

The power provisioning at the interfaces described above can cause power bottlenecks in a computer system, which can lead to a system crash. This is particularly true when a plurality of interfaces are attached to a computer system and thus a multiple of the power provided at each single interface can be tapped. Furthermore, power bottlenecks occur in particular when a computer system with such interfaces has a power supply unit with a limited output power as, for example, with so-called all-in-one PCs, laptops or comparable devices.

It could therefore be helpful to provide an interface arrangement, a computer system, and a method that addresses the above-mentioned problem.

### SUMMARY

We provide an interface arrangement including a first interface via which a first power supply can be provided, at least one second interface via which at least one second power supply can be provided, and a control device, wherein the first interface is connected to the control device via a connector of a first or a second type, the control device is configured to detect whether the first interface is connected to the control device via the connector of the first type or of the second type, and the control device is further configured to limit the at least one second power supply provided at the at least one second interface depending on the detected type of the connector.

We also provide a computer system including the interface arrangement including a first interface via which a first power supply can be provided, at least one second interface via which at least one second power supply can be provided, and a control device, wherein the first interface is connected to the control device via a connector of a first or a second type, the control device is configured to detect whether the first interface is connected to the control device via the connector of the first type or of the second type, and the control device is further configured to limit the at least one second power supply provided at the at least one second interface depending on the detected type of the connector.

We further provide a method for the interface arrangement including a first interface via which a first power supply can be provided, at least one second interface via which at least one second power supply can be provided, and a control device, wherein the first interface is connected to the control device via a connector of a first or a second type, the control device is configured to detect whether the first interface is connected to the control device via the connector of the first type or of the second type, and the control device is further configured to limit the at least one second power supply provided at the at least one second interface depending on the detected type of the connector, including connecting the first interface to the control device by the connector of the first type or the second type, detecting, by the control device, whether the first interface is connected to the control device by the connector of the first type or the second type, and limiting, by the control device, the at least one second power supply that can be provided via the at least one second interface if the connector of the second type has been detected.

### BRIEF DESCRIPTION OF THE DRAWINGS

FIG. 1 shows a drawing of a computer system according to an example.

FIG. 2 shows a drawing of an interface arrangement according to an example.

FIG. 3 shows a drawing of the interface arrangement according to FIG. 2 in a second configuration.

FIG. 4 shows a flowchart of a method for an interface arrangement according to an example.

### LIST OF REFERENCE SIGNS

1 computer system
2 housing
3 front side
4 front panel
5 power-on button
6, 6a, 6b first interface
7 interface arrangement
8, 8a, 8b front panel cable
9 front panel connector
10 system board
11 control device
12 second interface
13 microcontroller
14 interface controller
15 first contact
16 input contact pin
17 second contact
18 output contact pin
19 first pull-up resistor
20 second pull-up resistor
100-300 method steps

### DETAILED DESCRIPTION

We provide an interface arrangement. The interface arrangement comprises a first interface via which a first power supply can be provided, at least one second interface via which at least one second power supply can be provided, and a control device. The first interface is connected to the control device via a connector of a first or a second type. The control device is configured to detect whether the first interface is connected to the control device via the connector of the first type or of the second type. The control device is further configured to limit the at least one second power supply that can be provided at the at least one second interface depending on the detected type of connector.

Advantageously, the at least one second power supply that can be provided at the at least one second interface is reduced depending on the type of connector used. In this way, the power that can be provided at the at least one second interface can be selectively set to a predetermined maximum value. Depending on the configuration of the interface arrangement and the selection of a corresponding connector, it is thus possible to prevent excessive power from being tapped via the interface arrangement.

In addition, our approach is a hardware-based, secure way of limiting the at least one second power supply that can be provided. Such a hardware-based restriction of the power that can be delivered via the at least one second interface represents a significantly more error-resistant approach than alternative—software-based—approaches, or other handshake methods. Moreover, limitation of the power output via the at least one second interface achieved here is reversible—by exchanging the type of connector used—which ensures a higher flexibility compared to systems with rigid limitation of the power output per interface.

The first interface may be connected to the control device via the connector of the first type when the first interface is an interface of a first type. The first interface may be connected to the control device via the connector of the second type when the first interface is an interface of a second type. A higher maximum power supply can be provided at the interface of the first type than at the interface of the second type. The control device may be configured to limit the at least one second power supply when the connector of the first type has been detected.

It is advantageous here that the power supply via the at least one second interface is restricted when the first interface already allows a comparatively high power supply. In this example, a peripheral device that demands high power can be connected to the first interface —further peripheral devices or system-internal consumers that can be operated with lower power, can be connected to the at least one second interface.

The interface of the first type may be a USB type-C interface and the interface of the second type may be a USB type-A or a USB type-B interface.

Up to 7.5 watts can be provided at USB type-A and type-B interfaces depending on the specification used. Up to 15 watts can be provided at USB type-C interfaces, and even up to 100 watts when USB power delivery is used.

The connector may be connected to the control device via a mating connector. The control device may comprise a microcontroller. A first contact of the mating connector may connect to an input contact pin of the microcontroller. The connector of the first type may be configured such that, when the connector of the first type is connected to the mating connector, the first contact of the mating connector is grounded so that a “low” signal is applied to the input contact pin of the microcontroller. The connector of the second type may be configured such that, when the connector of the second type is connected to the mating connector, the first contact of the mating connector is free so that a “high” signal generated via an auxiliary voltage and a pull-up resistor is applied to the input contact pin of the microcontroller.

Advantageously, such a configuration of the connector of the first and second types, respectively, represent a simple and inexpensive solution by which the microcontroller can recognize the respective type of connector. In particular, the connector is a connector that is additionally used for provision of the first power supply as well as a data traffic via the first interface. Such a connector comprises a ground contact used here to ground the first contact of the mating connector, when the connector of the first type being used.

The first interface may be arranged on a housing, in particular a front panel of a computer system. The connector of the first or second type may be a front panel cable of a first or second type, respectively.

It is advantageous that peripheral devices, preferred by a user of a computer system, are frequently connected to such a first interface such as cell phones, tablet computers and the like. For example, for a fast charging, ensuring a high first power supply is advantageous in this configuration. If a high first power supply is provided, limiting the at least one second power supply is advantageous.

We also provide a computer system comprising an interface arrangement.

We further provide a method for an interface arrangement. The method comprises the following steps:

connecting the first interface to the control device via the connector of the first type or the second type,

detecting, by the control device, whether the first interface is connected to the control device via the connector of the first type or the second type, and

limiting, by the control device, the at least one second power supply provided via the at least one second interface if the connector of the second type has been detected.

Further advantages are described in the examples and following description of the attached figures. In the figures, the same reference signs are used for elements having substantially the same function, but these elements need not be identical in all details.

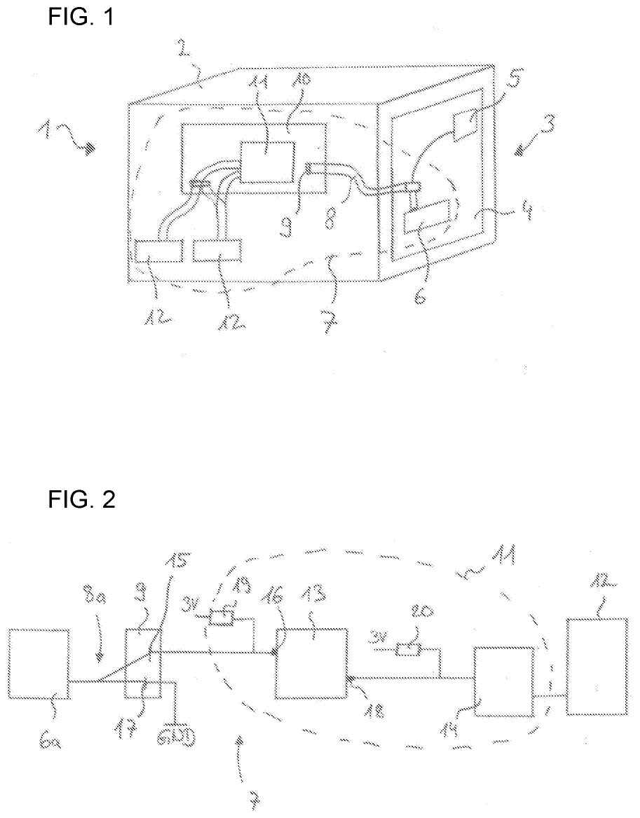

FIG. 1 shows a drawing of a computer system 1 according to an example. The computer system 1 has a housing 2, wherein a front panel 4 is attached to the housing 2 at a front side 3 of the computer system 1.

A power-on button 5 for the computer system 1 is located on the front panel 4 as well as a first interface 6 of an interface arrangement 7 of the computer system 1. In the example shown here, the first interface 6 is a USB interface, but can also be any other interface via which a power supply can be provided. The front panel 4 may have further elements not shown here.

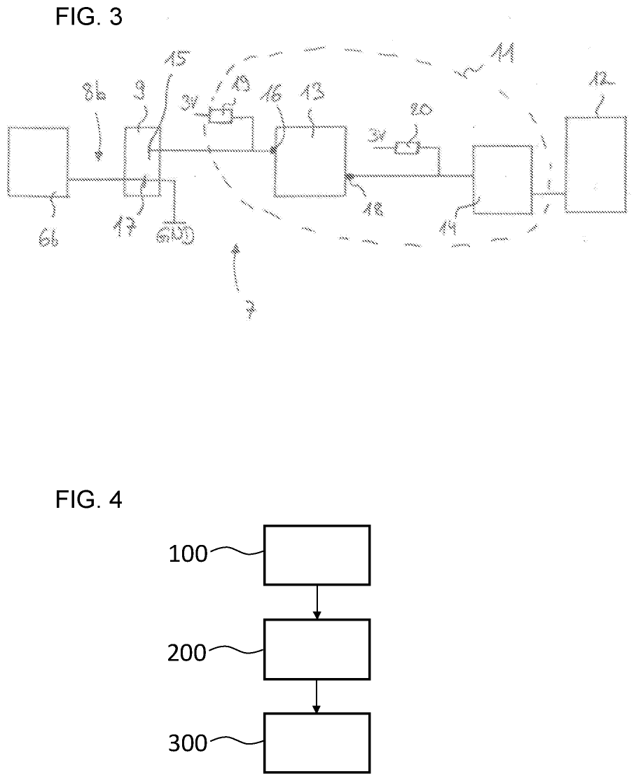

The front panel 4 is connected to a front panel connector 9 on a system board 10 of the computer system 1 via a front panel cable 8. Through the front panel cable 8, power supplies are provided to the elements of the front panel 4 such as, for example, the power-on button 5 and the first interface 6, and data traffic with these elements is realized. For the first interface 6, for example, the front panel cable 8 comprises a plurality of data lines through which data exchange with peripheral devices connected to the first interface 6 is realized. Further, for the first interface 6, the front panel cable 8 comprises at least one line that provides power and at least one ground line. The front panel cable 8 is described in more detail with reference to FIGS. 2 and 3.

The system board 10 further includes a control device 11 to which two second interfaces 12 are connected in the example shown herein. The second interfaces 12 are, for example, also USB interfaces, but can also be any other interfaces via which a power supply for connected devices can be provided. The second interfaces 12 are shown as external interfaces, but they can of course also be internal interfaces of the computer system 1 to which internal consumers of the computer system 1 are connected. The second interfaces 12 may also be arranged directly on the system board 10. An interconnection between the control device 11, the second interfaces 12 and the front panel connector 9 is arranged “on-board” on the system board 10 in the example shown here.

Functions and further details are described below with reference to FIGS. 2 and 3.

FIGS. 2 and 3 each show a drawing of an interface arrangement 7 according to one example. The interface arrangement 7 according to FIGS. 2 and 3 is, for example, the interface arrangement 7 of the computer system 1 according to FIG. 1. FIG. 2 shows a first configuration and FIG. 3 shows a second configuration of the interface arrangement 7.

The interface arrangement 7 according to FIGS. 2 and 3 respectively shows a first interface 6a, 6b, a front panel connector 9, a control device 11, and a second interface 12. The second interface 12 is a USB type-C interface via which a power of up to 15 watts can be provided to connected devices. Only one second interface 12 is shown here, but the interface arrangement 7 can comprise several further second interfaces 12 that can also be USB type-C or other types of interfaces.

The control device 11 comprises a microcontroller 13 and an interface controller 14 configured to control a power supply via the second interface 12. Such an interface controller 14 is also known in USB interfaces as a USB power controller.

The front panel connector 9 has a plurality of contacts, two of which are shown here. A first contact 15 of the front panel connector 9 is connected to an input contact pin 16, also known as a general purpose input pin (GPI pin) of the microcontroller 13. A second contact 17 of the front panel connector 9 is grounded. The microcontroller 13 further has an output contact pin 18, also known as a general purpose output pin (GPO pin), via which the microcontroller 13 is connected to the interface controller 14. An auxiliary voltage is interconnected to the connection between front panel connector 9 and microcontroller 13 via a first pullup resistor 19, and an auxiliary voltage is interconnected to the connection between microcontroller 13 and interface controller 14 via a second pullup resistor 20. The pullup resistors 19, 20 are chosen such that, with the auxiliary voltage, in the example shown here auxiliary voltages of 3 volt, digital “high” signals are generated which can be detected by the microcontroller 13 and the interface controller 14, respectively, if the respective connections are not grounded.

The respective first interface 6a, 6b is connected to the front panel connector 9 in both FIGS. 2 and 3, respectively, via a front panel cable 8a, 8b that is configured differently depending on the configuration of the interface arrangement 7.

FIG. 2 shows the interface arrangement 7 in a first configuration with the first interface 6a and the front panel cable 8a. In this example, the first interface 6a is a USB Type-C interface that can provide a high power supply of up to 15 watts. The front panel cable 8a connects a ground contact of the first interface 6 to the grounded second contact 17 of the front panel connector 9. Additionally, in the first configuration, the front panel cable 8a connects the grounded second contact 17 to the first contact 15 so that the connection between the first contact 15 of the front panel connector 9 and the input contact pin 16 of the microcontroller 13 is grounded. In this way, a detection signal on the input contact pin 16 is pulled to a “low” signal.

FIG. 3 shows the interface arrangement 7 in a second configuration with the first interface 6b and the front panel cable 8b. In this example, the first interface 6b is a USB Type-A, or USB Type-B interface that can provide a comparatively lower power supply of up to 7.5 watts. The front panel cable 8b connects a ground contact of the first interface 6 to the grounded second contact 17 of the front panel connector 9. The front panel cable 8b in the second configuration does not connect the grounded second contact 17 to the first contact 15, but the first contact 15 is open so that the connection between the first contact 15 of the front panel connector 9 and the input contact pin 16 of the microcontroller 13 is not grounded. In this way, the detection signal on the input contact pin 16 is pulled to a “high” signal by the auxiliary voltage of 3 volts and the first pull-up resistor 19.

In the first configuration according to FIG. 2, the microcontroller 13 applies a “low” signal to the output contact pin 18. This is used to signal to the interface controller 14 to restrict a power output via the second interface 12. According to the example shown here, the interface controller 14 limits a maximum current output via the second interface 12 to 0.9 amperes or 1.5 amperes according to the USB specification so that a maximum power output of 4.5 watts or 7.5 watts is possible at a voltage of 5 volts.

In the second configuration shown in FIG. 3, the microcontroller 13 applies a “high” signal to the output contact pin 18. This is used to signal to the interface controller 14 not to restrict a power output via the second interface 12. According to the example shown here, the interface controller 14 allows a maximum current output via the second interface 12 according to the USB specification of 3 amperes so that a maximum power output of 15 watts is possible at a voltage of 5 volts. Alternatively, it is also possible to apply the detection signals applied to the input contact pin 16 to the interface controller 14. The detection of the front panel cables 8a, 8b and the corresponding limitation of the power output via the second interface 12, could of course also be realized in reverse.

FIG. 4 shows a flow chart of a method for an interface arrangement according to an example. The interface arrangement comprises a first interface via which a first power supply can be provided, at least one second interface, via which at least one second power supply can be provided, and a control device. The method is suitable, for example, for the interface arrangement 7 according to FIGS. 1 to 3.

In a first step 100, the first interface is connected to the control device via a connector of a first type or a second type.

In a second step 200, the control device detects whether the first interface is connected to the control device via the connector of the first type or the second type.

In a third step 300, the control device limits the at least one second power supply that can be provided via the at least one second interface if the connector of the second type has been detected.

1. An interface arrangement comprising:
a first interface via which a first power supply can be provided,
at least one second interface via which at least one second power supply can be provided, and
a control device, wherein
the first interface is connected to the control device via a connector of a first or a second type,
the control device is configured to detect whether the first interface is connected to the control device via the connector of the first type or of the second type, and
the control device is further configured to limit the at least one second power supply provided at the at least one second interface depending on the detected type of the connector.

2. The interface arrangement according to claim 1, wherein
the first interface is connected to the control device via the connector of the first type when the first interface is an interface of a first type, the first interface is connected to the control device via the connector of the second type when the first interface is an interface of a second type, and a higher maximum power supply can be provided at the interface of the first type than at the interface of the second type, and
the control device is configured to limit the at least one second power supply when the connector of the first type has been detected.

3. The interface arrangement according to claim 2, wherein
the interface of the first type is a USB type-C interface, and
the interface of the second type is a USB type-A or a USB type-B interface.

4. The interface arrangement according to claim 1, wherein
the connector is connected to the control device via a mating connector,
the control device comprises a microcontroller,
a first contact of the mating connector is connected to an input contact pin of the microcontroller,
the connector of the first type is configured such that, when the connector of the first type is connected to the mating connector, the first contact of the mating connector is grounded so that a “low” signal is applied to the input contact pin of the microcontroller, and
the connector of the second type is configured such that, when the connector of the second type is connected to the mating connector, the first contact of the mating connector is free so that a “high” signal generated via an auxiliary voltage and a first pull-up resistor is applied to the input contact pin of the microcontroller.

5. The interface arrangement according to claim 4, wherein
the control device further comprises an interface controller connected to an output contact pin of the microcontroller,
the microcontroller is configured to signal the detected type of connector to the interface controller, and
the interface controller is configured to realize the restriction of the at least one second power supply via the at least one second interface.

6. The interface arrangement according to claim 5, wherein the interface controller is a USB power controller.

7. The interface arrangement according to claim 1, wherein
the first interface is arranged on a housing of a computer system, and
the connector of the first or second type is a front panel cable of a first or second type, respectively.

8. The interface arrangement according to claim 7, wherein the first interface is arranged on a front panel of computer system.

9. A computer system comprising the interface arrangement according to claim 1.

10. A method for the interface arrangement according to claim 1, comprising:
connecting the first interface to the control device by the connector of the first type or the second type,
detecting, by the control device, whether the first interface is connected to the control device by the connector of the first type or the second type, and
limiting, by the control device, the at least one second power supply that can be provided via the at least one second interface if the connector of the second type has been detected.
